(19) United States
(12) Patent Application Publication
(10) Pub. No.: US 2007/0010315 A1
(43) Pub. Date: Jan. 11, 2007

(54) Hierarchy of celebration graphics

(76) Inventor: Marvin A. Hein, Las Vegas, NV (US)

Correspondence Address: BROWN RAYSMAN MILLSTEIN FELDER & STEINER, LLP, 1880 CENTURY PARK EAST, 12TH FLOOR, LOS ANGELES, CA, 90067, US

(21) Appl. No.: 11/176,432

(22) Filed: Jul. 6, 2005

(51) Int. Cl. A63F 9/24; A63F 13/00

(52) U.S. Cl. 463/20

(57) ABSTRACT

Hierarchical systems of celebration graphics for use with gaming machines are disclosed. In one embodiment, a gaming machine comprises a cabinet having a game display and a gaming mechanism for providing a game for play on the gaming machine. The game has one or more winning combinations of symbols and the winning combinations have varying values. A memory is connected to the gaming machine for storing a plurality of varying celebration graphics. The occurrence of a winning combination in the game triggers the presentation, on the display, of a particular celebration graphic depending on the value of the winning combination.

### BACKGROUND

Generally, casino video games involve achieving winning symbols on a video screen. Most games have a variety of such winning combinations of symbols. If a player matches a combination according to the rules of the game, the gaming machine pays the player cash or some other sort of value, such as extra games. In many games, when the player obtains a “winning combination” of symbols, the gaming machine will then display some type of graphic to celebrate the win.

Typically, the various winning combinations have different values. Currently, when a winning combination occurs, the same graphic is displayed to celebrate the win regardless of the value of the winning combination. In some games, an animated graphic is used to celebrate the win. Generally the same animated graphic is used to celebrate both a small win and a large win. However, this celebration scenario can leave a negative impact on a player. For example, many players who experience a small win want to quickly move on and continue the game. For these players, being. forced to wait through a long celebration can be both annoying and frustrating, thus leaving a negative impact on the player.

Additionally, other games have a binary celebration system. All winning combinations are divided into a “small win” category and a “large win” category. In this scenario, animated graphics are not displayed for a small win. Rather, only large wins are celebrated, thereby making a small win celebration equivalent to a no-win celebration. Additionally, mid-range wins and large wins are celebrated the same. What is needed is an apparatus and method for providing and displaying different variations of celebration graphics depending on the relative range of the win.

### BRIEF SUMMARY

Briefly, and in general terms, various embodiments for a hierarchical system of celebration graphics are disclosed herein. One embodiment is directed to a gaming machine comprising a cabinet having a game display and a gaming mechanism for providing a game for play on the gaming machine. The game has one or more winning combinations of symbols and the winning combinations have varying values. A memory is connected to the gaming machine for storing a plurality of varying celebration graphics. The occurrence of a winning combination in the game triggers the presentation, on the display, of a particular celebration graphic depending on the value of the winning combination.

Another embodiment provides a method for celebrating winning symbol combinations for a game on a gaming machine. The method comprises initiating play of the game on the gaming machine. At the prompt of a user, one or more symbols are presented on a gaming machine display. Next, it is determined whether the combination of presented symbols matches predetermined winning symbol combinations, which have varying values. A memory storing a hierarchy of celebration graphics is accessed. The celebration graphic that corresponds to the value of the winning symbol combination is retrieved and presented on the display to celebrate the winning symbol combination.

### BRIEF DESCRIPTION OF THE DRAWINGS

FIG. 1 is an illustration of a gaming machine comprising an embodiment of a hierarchical system of celebration graphics.

FIG. 2 is an illustration of gaming machine displays comprising an embodiment of a hierarchical system of celebration graphics.

FIG. 3 is a table illustrating different levels of winning combination payout values according to an embodiment of the hierarchical system of celebration graphics.

FIG. 4 is a table illustrating different levels of winning combination payout values according to an embodiment of the hierarchical system of celebration graphics.

FIG. 5 is an illustration of gaming machine displays comprising an embodiment of a hierarchical system of celebration graphics.

FIG. 6 is an illustration of a gaming machine comprising an embodiment of a hierarchical system of celebration graphics.

### DETAILED DESCRIPTION

Various embodiments are directed to a hierarchical system of celebration graphics for use with a plurality of different gaming systems. More particularly, the hierarchical system presents graphic celebrations during play of a game based on the value of a win. Embodiments of the system and method are illustrated and described herein, by way of example only, and not by way of limitation.

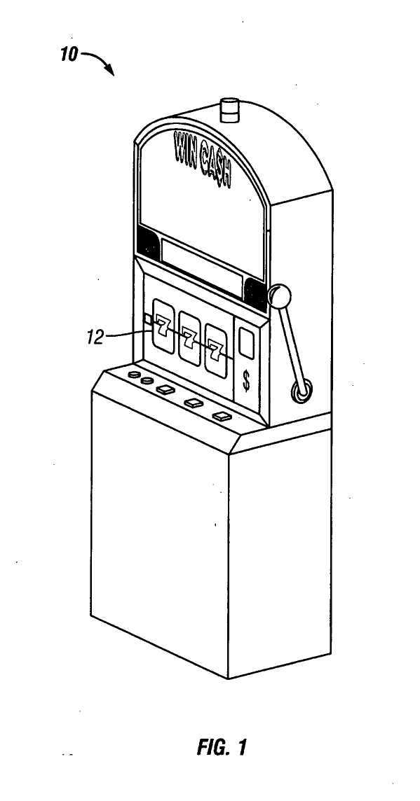

Referring now to the drawings, wherein like reference numerals denote like or corresponding parts throughout the drawings and, more particularly to FIGS. 1-6, there is shown various embodiments of a hierarchical system of celebration graphics.

In one embodiment, a gaming machine includes a hierarchical system of celebration graphics. The celebration graphic is a graphical depiction that is presented after a winning outcome on a gaming machine. In one embodiment, the graphic may be a two-dimensional or a three-dimensional image. In another embodiment, the celebration graphic may be animated. In yet another embodiment, the celebration graphic comprises photographs and/or movie clips. Optionally, the presentation of the celebration graphic may include sound (e.g., music, dialogue, or sound effects). Generally, the duration and features of a particular celebration graphic correspond to the value of the winning outcome. Essentially, any form or combination of media may be used to create and present a celebration graphic.

Referring now to FIG. 1, a gaming machine 10 having a display 12 is shown. In various embodiments, the display 12 is a video display such as, but not limited to, a CRT (cathode ray tube), or a thin-panel display. Examples of thin-panel displays include plasma, LCD (liquid crystal display), electroluminescent, vacuum fluorescent, field emission, or any other types of thin panel displays known or developed in the art. In various embodiments, the gaming machine 10 may be a mechanical slot machine, video slot machine, video poker machine, keno machine, video blackjack machine, or a gaming machine offering one or more of the above-described games.

In some embodiments, the gaming machine 10 also comprises a gaming mechanism (not shown), which provides a game for play on the gaming machine 10. In other embodiments, the gaming mechanism provides a plurality of games for play on the gaming machine 10.

In one embodiment, the gaming machine 10 is capable of displaying one or more games on the display 12. A game player activates a game on the gaming machine 10 and the resulting game outcome is shown on the display 12. If the resulting game outcome includes a winning combination of symbols, then one or more celebration graphics corresponding to the value of the winning combination are shown on the display 12. For instance, in one embodiment winning combinations having payout values in the range of 1-10 credits are associated with a particular celebration graphic, and payout values in the range of 10-100 credits are associated with a more elaborate celebration graphic. Additionally, the jackpot payout may be associated with the most elaborate celebration graphic. In this manner, the gaming machine provides a player with incentive to play the game to view the various celebration graphics. As a result, the gaming device creates and maintains more excitement for a player. As those skilled in the art will appreciate, the payout values may be categorized into a variety of ranges. Accordingly, the above example is merely one illustration of such payout ranges and is not intended as a limitation.

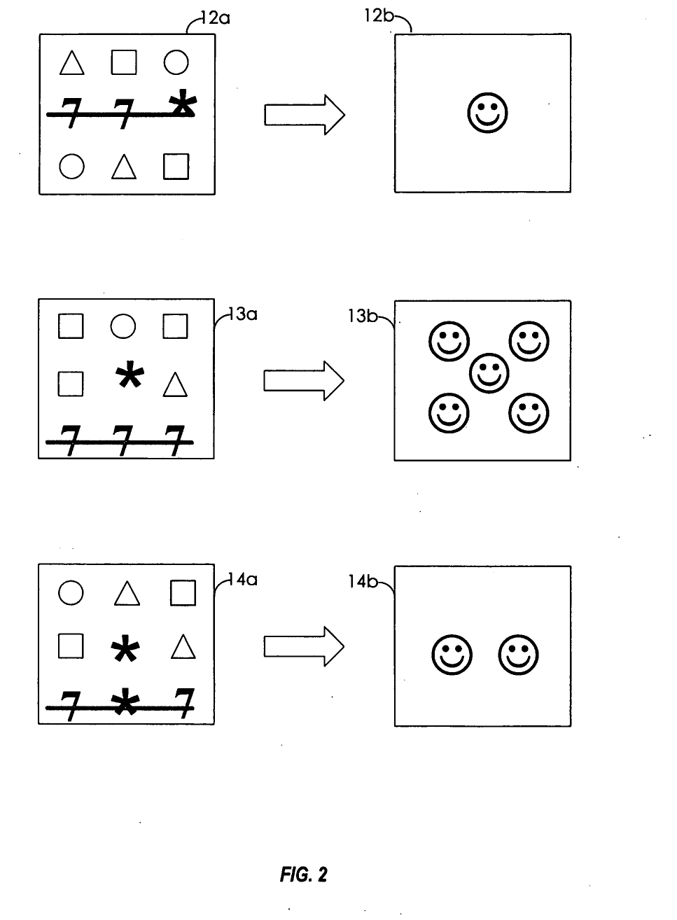

Referring to FIG. 2, an initial gaming machine display 12a and a resulting gaming machine display 12b are shown. The initial gaming machine display 12a shows the winning combination “7 7*” in the display window. The occurrence of this winning combination triggers the presentation of a celebration graphic, which is shown in the resulting gaming machine display 12b.

Also shown in FIG. 2 is an initial gaming machine display 13a and a resulting gaming machine display 13b. The occurrence of the winning combination “7 7 7” is shown in the initial gaming machine display 13a. This winning combination has a larger payout value than the winning combination shown in the first initial gaming display 12a. As a result, this winning combination triggers the presentation of a different celebration graphic than the one presented in resulting gaming machine display 12b. The celebration graphic shown in the resulting gaming machine display 13b includes five symbols while the celebration graphic shown in display 12b only includes one symbol. When the winning combination for the jackpot occurs, an even more elaborate celebration graphic (not shown) is presented.

In one embodiment, the event that triggers the celebration graphic is the presentation of one or more winning combinations on the display 12, in FIG. 1. Depending upon the value (which corresponds to the odds of achieving the winning outcome), a corresponding celebration graphic is displayed. In another embodiment, the triggering event is the occurrence of a bonus symbol on a payline.

Generally, most games have a variety of winning symbol combinations and a particular payout value is associated with each of the winning symbol combinations. Typically, the manufacturer or the casino determines the particular payout scheme of a game and assigns payout values to the various winning symbol combinations. In one embodiment, the assigned payout values are based on a standard payout table. Alternatively, in another embodiment, the assigned payout values are based on a non-standard payout table. Optionally, in another embodiment, the payout scheme includes scatter pays, wherein the scatter pay is a win comprising non-adjacent symbols. Referring to FIG. 2, the winning combination “7 * 7” shown in the initial gaming machine display 14a is a scatter-pay-win. As such, the winning combination triggers the occurrence of a particular celebration graphic corresponding to the value of the winning combination (i.e., “7 * 7”).

In an optional embodiment, the payout scheme includes a transposed pay table, wherein the transposed pay table applies to symbol combinations that are in reverse order as compared to a standard pay table. That is, winning combinations are generally read from left to right. However, when using a transposed pay table, the winning symbol combinations are reversed such that the winning combinations are “read” right to left. For example, referring to FIG. 2, the standard table pays out coins for a “7 7 * ” symbol combination as shown in display 12a. A transposed pay table would pay out for a “* 7 7 ” combination (not shown).

In various embodiments of the gaming machine 10, the celebration graphics are stored in a memory device (not shown). By way of example, but not by limitation, such devices include external memory devices, hard drives, CD-ROMs, DVDs, and flash memory cards. In an alternative embodiment, the celebration graphics are stored in a remote storage device. In one embodiment, the remote storage device is housed in a remote server. The gaming machine may access the remote storage device via a network connection, including but not limited to a wireless connection.

In one embodiment, the amount of time the celebration graphics are presented on the display corresponds to the value of the winning combinations. As those skilled in the art will appreciate, the varying values of the winning combinations range from a predetermined minimum value to a predetermined maximum value. For instance, a small winning amount (e.g., 10 credits) will prompt the display of a simple celebration graphic. For example, the simple celebration graphic is short in duration (e.g., 2 seconds). For a larger winning amount (e.g., 25 credits) the celebration graphic is longer in duration (e.g., 5 seconds). For an even larger winning amount (e.g. 100 credits) the celebration graphic is even longer in duration (e.g. 10 seconds). As those skilled in the art will appreciate, the duration of the celebration graphic may be programmed by the manufacturer or casino operator. Additionally, the values of the winning combinations may be categorized into various levels by the manufacturer or casino operator, wherein each level may comprise a range of values. As those skilled in the art will appreciate, an infinite number of categorizations is possible.

In another embodiment, the complexity of the presented celebration graphic varies and depends on the values of the winning combinations. For instance, a small winning amount (e.g., 5 credits) will prompt the display of a simple celebration graphic. For example, the simple celebration graphic is a picture of one symbol. For a larger winning amount (e.g., 50 credits) the celebration graphic is more complex. For example, the more complex celebration graphic may be a picture comprising ten (10) animated symbols. For an even larger winning amount (e.g., 250 credits) the animated graphic may comprise fifteen (15) animated symbols and may include sound. As those skilled in the art will appreciate, the duration of the celebration graphic may be programmed by the manufacturer or casino operator. Additionally, the values of the winning combinations may be categorized into various levels by the manufacturer or casino operator, wherein each level may comprise a range of values. As those skilled in the art will appreciate, an infinite number of categorizations is possible.

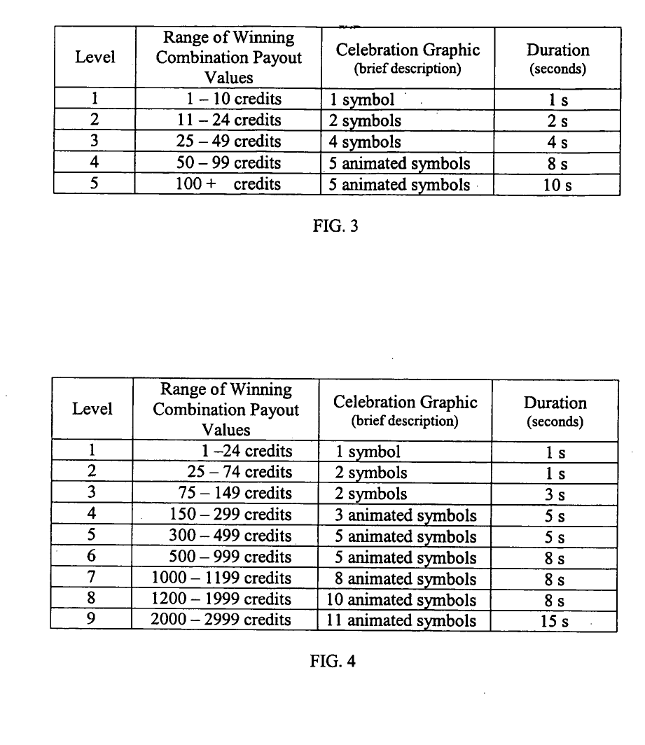

In one embodiment, the payout values of the winning combinations are categorized into five different levels. Referring to FIG. 3, a table illustrating the five different levels of payout values is shown. Level one includes winning combinations having payout values ranging from 1 to 10 credits. Level two includes winning combinations having payout values ranging from 11 to 24 credits. Level three includes winning combinations having payout values ranging from 25 to 49 credits. Level four includes winning combinations having payout values ranging from 50-99 credits. Level five includes winning combinations having payout values ranging from 100 credits to a predetermined maximum number of credits. A particular celebration graphic and the duration of its display are associated with each level. For example, a winning outcome worth 2 credits corresponds to a “level one” win. Accordingly, for a level one win, a simple “one symbol” celebration graphic is displayed for one second. As seen in the table shown in FIG. 3, the celebration graphics vary according to the level of the winning outcome. As those skilled in the art will appreciate, multiple configurations for winning outcome levels are possible. The table shown in FIG. 3 is merely illustrative and does not serve to limit the levels of payout values to the ranges specified in the example.

In another embodiment, the winning combination payout values are categorized into nine different levels. Referring to FIG. 4, a table illustrating the nine different levels is shown. A particular celebration graphic and the duration of its display are associated with each level. As those skilled in the art will appreciate, any number of levels may be defined and the table shown in FIG. 4 does not serve to limit the levels of payout values to the ranges specified in the example.

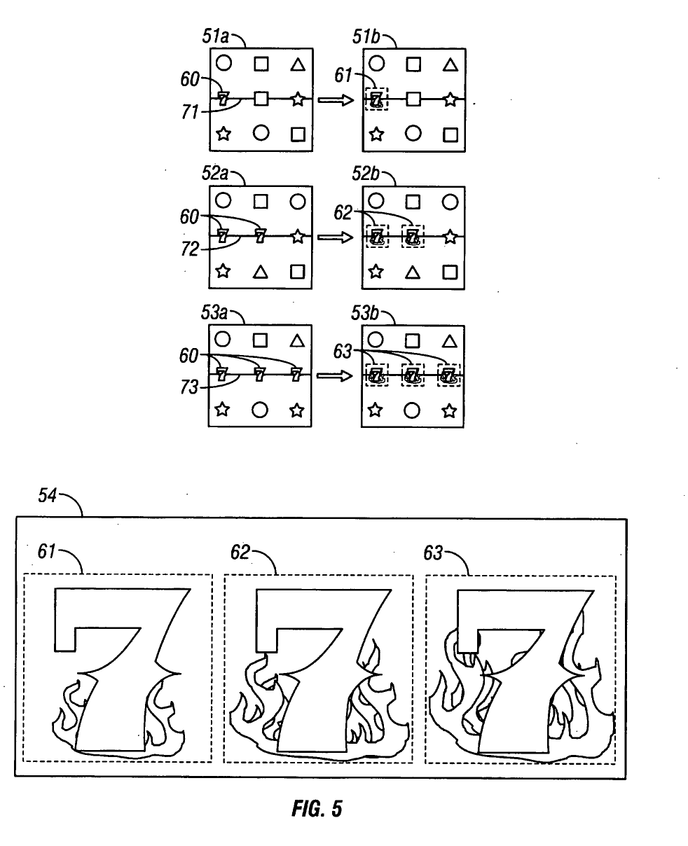

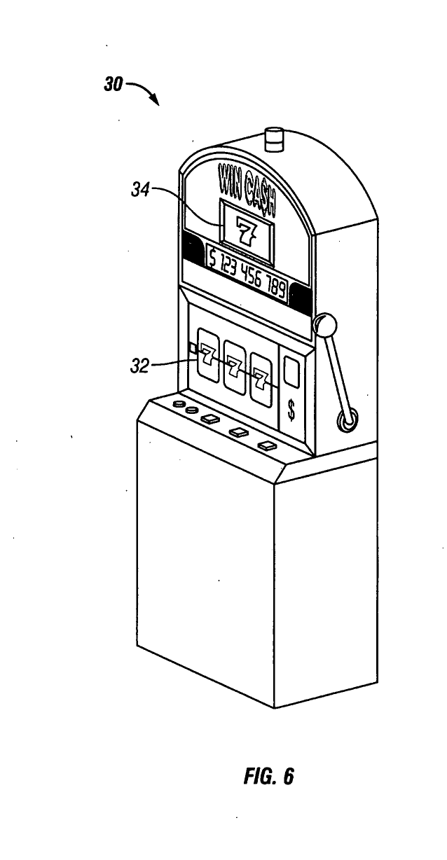

In one embodiment, the celebration graphics are in the form of substitution symbols. For example, when a symbol on the gaming machine display is part of a winning combination, the symbol is substituted with an animated symbol to denote a win. Referring now to FIG. 5, various symbols in a video reel game are shown on the display 51a. In this particular example, when a red “7” symbol (not shown in color in FIG. 5) is part of a winning combination, the red “7” symbol “changes” into an animated “7” with a blazing fire surrounding the number. In other words, the red “7” symbol is substituted with an animated symbol having fire that appears to blaze. In one embodiment, the amount of time the animated symbol is displayed depends on the value of the win. In another embodiment, the content of the animated symbol depends on the value of the win.

Referring back to FIG. 5, a winning line 71 is shown in the display 51a. In this example, the winning line 71 is a small win and as a result the red “7” symbol 60 is substituted with an animated symbol 61 having a “small fire” surrounding the number “7” (as shown in display 51b). In the display 52a, a winning line 72 having two red “7” symbols 60 is shown. In display 52b, each of the red “7” symbols 60 have been substituted with an animated symbol 62. Since the winning line 72 is worth more than the winning line 71, each of the animated symbols 62 have animated fire larger than the animated fire in the animated symbol 61. Additionally, the display 53a shows a winning line 73 having three red “7” symbols 60. The winning line 73 is a “big win” and as a result each red “7” symbol 60 in winning line 73 is substituted with an animated “7” 63 having a big blazing fire, as shown in display 53b. A table 54 showing blown-up versions of animated symbols 61, 62 and 63 is provided in FIG. 5. As those skilled in the art will appreciate, the types of animated graphics used as substitution symbols will vary according to the needs of the game.

In one embodiment the win values are divided into various levels and each level is associated with a particular celebration graphic. For example, when a first level win (the smallest win) occurs, a red “7” is substituted with an animated blazing “7” for one second. The animated figure appears to burn for the one second it is displayed on the screen. For a second level win, the red “7” is again substituted with an animated blazing “7”, but is displayed f or two seconds. For a third level win, a red “7” is substituted with an animated blazing “7”. However, in the celebration graphic associated with a third level win, the fire surrounding the “7” blazes higher and more fiercely than the fire shown for the lower level wins. Additionally, the blazing fire is displayed for three seconds. For a fourth level win, one or more red “7”s are substituted with an animated blazing “7” for at least three seconds. For the highest level win, one or more red “7”s are substituted with an animated blazing “7” and then the entire screen turns into a raging inferno and fire engine sounds are heard. In an alternate embodiment, sound accompanies the display of the animated blazing “7” for any level win. Optionally, the sound may simulate the sounds of a fire blazing.

In another embodiment, the features of the celebration graphic are based upon two factors such as the winning combination and the amount of the player's wager. For instance, a small winning combination and a small wager result in a short and simple celebration graphic. If the winning combination has a small value, but the player has made a maximum bet, the celebration graphic may be longer in duration and more complex. As those skilled in the art will appreciate, the factors that affect the duration and complexity of the celebration graphic may be determined and configured by the manufacturer or casino operator.

In an alternative embodiment, the celebration graphic is an interactive celebration graphic. The celebration graphic may include player data such as, but not limited to, player name, player birthday, or an image of the player. In an optional embodiment, the interactive celebration graphic may include a character or other animated graphic announcing the player's name. Alternatively, a banner may display the player's name. In another embodiment, the player's data may be obtained when the player inserts a player tracking card into the gaming machine. Optionally, the player data may be obtained when a player inputs biographical data into the gaming machine. In yet another embodiment, the gaming machine may include a camera to capture an image of the player. This image may then be incorporated into the celebration graphic.

In another embodiment, the celebration graphic may be interactive in that the player can terminate the celebration graphic before the end of the graphic. Optionally, the player can mute the music or dialogue that is also presented with the celebration graphic.

In another embodiment, the celebration graphic is generic to the gaming machine. For instance, the celebration graphic may flash on the display screen, “Congratulations! You've won 10 credits!” and have a graphical depiction of floating balloons, streamers, and sound makers. The complexity of the celebration graphic increases with more graphical features and sounds for larger winning combinations. Furthermore, the duration of the celebration graphic may be longer for higher winning combinations.

In another embodiment, the celebration graphic corresponds to the theme of the game. In one example, the theme of a gaming machine is “Gold Rush.” For a small winning combination, the celebration screen may show a character finding a small amount of gold. The character may then briefly dance, holler or hum a tune. For a large winning combination, the celebration graphic may show a character finding a large amount of gold, and, then the character may start singing and dancing for a longer amount of time. As those skilled in the art will appreciate, the elaborate nature of the graphic depends upon the amount of the winning outcome.

In an alternative embodiment, the celebration graphic may be based on such factors as time, date, weather, etc. For example, if a player is playing a game on July 4^{th}, the celebration graphic presented might be fireworks. As those skilled in the art will appreciate, the firework themed graphics may vary in complexity to correspond to the win amount. Optionally, in another embodiment, the celebration graphic incorporates features of current weather conditions. For example, if the weather is raining, the celebration graphic could include an animated rainfall. Alternatively, the time of day may be incorporated into the celebration graphic. For example, in the morning, the celebration graphic could include an animated display of the sun rising.

In one embodiment, the gaming machine comprises more than one display. Referring now to FIG. 6, the gaming machine 100 comprises a first display 102 and a second display 104. In another embodiment, the first display 102 of the gaming machine 100 displays mechanical reels (not shown). The second display 104 presents a celebration graphic upon the occurrence of a winning combination. Alternatively, in one embodiment, the celebration graphics are presented only on the first display 102. In another embodiment, the celebration graphics are only presented on the second display 104. In yet another embodiment, the celebration graphics are presented on both the first and second displays 102 and 104. Optionally, in an alternate embodiment, a gaming machine may have more than two displays (not shown) and celebration graphics may be presented on any combination of the displays.

Additionally, various embodiments of the gaming machines include a microprocessor for determining whether a prize is to be awarded based upon the outcome of the game (not shown). The microprocessor also determines whether a triggering event is present to initiate the presentation of a celebration graphic.

Optionally, another embodiment provides a method for celebrating winning symbol combinations for a game on a gaming machine. The method comprises beginning play of the game on the gaming machine. At the prompt of a user, one or more symbols are presented on a gaming machine display. Next, it is determined whether the combination of presented symbols matches predetermined winning symbol combinations. The winning symbol combinations have varying values. A memory storing a hierarchy of celebration graphics is accessed and the celebration graphic that corresponds to the value of the winning symbol combination is retrieved. The retrieved celebration graphic is then presented on the display to celebrate the winning symbol combination.

The various embodiments described above are provided by way of illustration only and should not be construed to limit the invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed is:

1. A gaming machine, comprising:
a game having one or more winning combinations of symbols, wherein the winning combinations have varying values;
a display for displaying the game; and
a memory storing a plurality of varying celebration graphics, wherein the occurrence of a winning combination triggers the presentation, on the display, of a particular celebration graphic depending upon the value of the winning combination.

2. The gaming machine of claim 1, wherein the values of the one or more winning combinations are categorized into a plurality of levels, and a particular celebration graphic is associated with each level.

3. The gaming machine of claim 1, wherein the varying values of the winning combinations range from a predetermined minimum value to a predetermined maximum value.

4. The gaming machine of claim 1, wherein the amount of time the celebration graphic is presented on the display depends on the value of the winning combination.

5. The gaming machine of claim 1, wherein the varying celebration graphics comprise animated graphics and the duration of the presented animated graphic depends on the value of the winning combination.

6. The gaming machine of claim 1, wherein the presentation of the particular celebration graphic includes sound.

7. The gaming machine of claim 1, wherein the plurality of celebration graphics have varying degrees of complexity that correspond to the values of the winning combinations.

8. The gaming machine of claim 1, wherein one or more of the plurality of celebration graphics is a user-interactive graphic.

9. The gaming machine of claim 1, wherein the game has a theme and the celebration graphics correspond to the theme of the game.

10. The gaming machine of claim 1, further comprising a secondary display, wherein the triggered celebration graphic is presented on the secondary display.

11. The gaming machine of claim 1, wherein the amount of time the celebration graphic is presented on the display depends on an amount of a wager.

12. The gaming machine of claim 1, wherein the celebration graphic comprises photographs, movie clips, or a combination thereof.

13. The gaming machine of claim 1, further comprising a player tracking feature.

14. The gaming machine of claim 1, further comprising a camera, wherein images from the camera are incorporated into the celebration graphics.

15. The gaming machine of claim 1, wherein the celebration graphic varies based upon at least one of the winning combination value, player information, date, and time.

16. The gaming machine of claim 1, wherein the celebration graphic comprises one or more substitution symbols.

17. The gaming machine of claim 1, wherein each winning symbol combination is assigned a payout value based on a standard pay table.

18. The gaming machine of claim 1, wherein each winning symbol combination is assigned a payout value based on a non-standard pay table.

19. The gaming machine of claim 1, wherein each winning symbol combination is assigned a payout value based on a predetermined pay scheme and the pay scheme includes scatter pays.

20. A method for celebrating winning symbol combinations in a game on a gaming machine, the method comprising:
beginning play of the game on a gaming machine;
presenting one or more symbols on a gaming machine display, at the prompt of a user;
determining whether the combination of presented symbols matches predetermined winning symbol combinations, wherein the winning symbol combinations have varying values;
accessing a memory storing a hierarchy of celebration graphics;
retrieving one or more than one celebration graphic that corresponds to the value of the winning symbol combination; and
presenting the one or more than one retrieved celebration graphic on the display to celebrate the winning symbol combination.

21. The method of claim 20, further comprising categorizing the varying values of the winning combinations into a plurality of levels such that a particular celebration graphic corresponds to each level.

22. The method of claim 20, wherein the amount of time the celebration graphic is presented on the display depends on the value of the winning combination.

23. The method of claim 20, wherein the celebration graphics comprise animated graphics and the duration of the presented animated graphic depends on the value of the winning combination.

24. The method of claim 20, wherein the presentation of the particular celebration graphic includes sound.

25. The method of claim 20, wherein the celebration graphics have varying degrees of complexity that correspond to the values of the winning combinations.

26. The method of claim 20, wherein one or more of the plurality of celebration graphics is a user-interactive graphic.

27. The method of claim 20, further comprising capturing an image from a camera, wherein the captured image is incorporated into the celebration graphics.

28. The method of claim 20, further comprising identifying a player.

29. The method of claim 20, further comprising presenting a celebration graphic on a second display.

30. The method of claim 20, wherein the celebration graphic varies based upon at least one of a winning value, player information, date, and time.

31. The method of claim 20, wherein the celebration graphic comprises one or more substitution symbols.

32. The method of claim 20, further comprising assigning a particular payout value to each winning symbol combination, wherein the payout value is based on a standard pay table.

33. The method of claim 20, further comprising assigning a particular payout value to each winning symbol combination, wherein the payout value is based on a non-standard pay table.

34. The method of claim 20, further comprising assigning a payout value to each winning symbol combination, wherein the payout value is based on a predetermined pay scheme and the pay scheme includes scatter pays.
